(19) United States
(12) Patent Application Publication
(10) Pub. No.: US 2022/0405672 A1
(43) Pub. Date: Dec. 22, 2022

(54) SYSTEM FOR MANAGEMENT OF FACILITY CONSTRUCTION AND MAINTENANCE

(71) Applicant: BUILTSPACE TECHNOLOGIES CORP., Vancouver (CA)

(72) Inventors: Ricky James ROLSTON, West Vancouver (CA); Daniel James FOX, Bainsville (CA)

(21) Appl. No.: 17/846,637

(22) Filed: Jun. 22, 2022

Related U.S. Application Data
(60) Provisional application No. 63/213,617, filed on Jun. 22, 2021.

(51) Int. Cl. G06Q 10/06

(52) U.S. Cl. CPC G06Q 10/06315; G06Q 10/06312; G06Q 10/06311; G06Q 50/08

(57) ABSTRACT

A system for managing construction and maintenance of a facility comprises a server, a database, asset tags, user devices, and administrator devices. The database stores asset records, with the asset records associated with a building asset and comprising information regarding the associated building asset. The asset tag is attached to and associated with a building asset. The user devices interact with the asset tag to identify the associated building asset and to transmit to the server information regarding status, completion, or activity regarding the building asset for recordal in the associated asset record. The administrator devices retrieve from the server information regarding the building assets by accessing the associated asset records and to display the information regarding the building assets on the administrator devices. The server generates a virtual model representing a current state of the facility based on the asset records.

### CROSS-REFERENCE TO RELATED APPLICATIONS

This application claims the benefit of U.S. Provisional Patent Application No. 63/213,617 filed Jun. 22, 2021, the contents of which are hereby incorporated by reference in its entirety.

### FIELD OF THE INVENTION

The present invention relates to systems for managing facility construction and maintenance, and in particular, to systems for managing facility construction and maintenance through a computer platform.

### BACKGROUND OF THE INVENTION

The construction and operation of a facility (such as a building) requires elaborate planning and scheduling of activities. Such activities may include the scheduling of the installation of new build components and the testing, installation, and maintenance of equipment assets. During the construction phase, each new installation activity may be contingent on successful completion of one or more previous activities or prerequisites. Construction prerequisites are typically planned out in advance by the building engineer and may be scheduled in a table of dependencies, where the prerequisites are conveniently listed to ensure they are completed before the work order for the next activity is assigned. The prerequisites may be subject to verification, commissioning, and/or compliance testing. If one of the prerequisites is found to have failed or is found to be deficient, it needs to be corrected before the work order for the next activity can be assigned.

In an operational building, scheduled activities may include the maintenance and testing of equipment assets and periodic testing of build components, such as envelope seals, membranes, and structures. These activities in an operational building need to be scheduled and executed, and the results of such maintenance and testing are typically recorded in paper files submitted by the work crew performing the activity.

It can be seen that most of the activities in the construction and operation of a facility require interaction of different trades in a carefully choreographed manner. Needless to say, the construction and operation of a facility can be enormously complex, and the processes developed and implemented to date are typically fraught with inaccuracies and constantly subject to revision. As a result, much data may be lost or may be prone to error, and important details may be difficult to discern or to pass on to subsequent users who need to know the information. There is therefore a desire for a system that is able to effectively and efficiently monitor and carry out the construction and maintenance of a facility.

### SUMMARY OF THE INVENTION

In accordance with one embodiment of the invention, a system is provided for management of construction and maintenance of a facility with a plurality of building assets. The system comprises a server, a database, one or more asset tags, one or more user devices, and one or more administrator devices. The database is in communications with the server. The database is configured to store one or more asset records, with each of the one or more asset records associated with one of the building assets and comprising information regarding the building assets associated therewith. Each of the one more asset tags is attached to and associated with one of the building assets. Each of the one or more user devices is in communications with the server and is configured to interact with one of the asset tags to identify the building asset associated therewith and to transmit to the server information regarding status, completion, or activity regarding the building asset for recordal in the asset record associated therewith. Each of the one or more administrator devices is in communications with the server and configured to retrieve from the server information regarding one or more of the building assets by accessing the asset records associated therewith and to display the information regarding one or more of the building assets on the administrator devices. The server is further configured to generate a virtual model representing a current state of the facility based, at least in part, on the asset records.

In another embodiment, the information regarding status or completion of the building asset comprises one or more of the following: photographs, time stamps, textual feedback, measurements, and specifications.

In yet another embodiment, the information regarding status, completion, or activity regarding the building asset is recorded in the asset record associated with the building asset.

In still another embodiment, the asset record further comprises information regarding a sequencing of construction involving the building asset associated therewith.

In still yet another embodiment, the information regarding the sequencing of construction comprises information on other ones of the building assets that need to be completed prior to completion of the building asset associated with the asset record.

In a further embodiment, the server is further configured to generate a schedule based, at least in part, on information in the asset records regarding the sequencing of construction and on the virtual model.

In still a further embodiment, the asset record further comprises information regarding a sequencing of maintenance involving the building asset associated therewith.

In another embodiment, the information regarding the sequencing of maintenance comprises information on other ones of the building assets that need to be worked on prior to maintenance of the building asset associated with the asset record.

In still another embodiment, the server is further configured to generate a schedule based, at least in part, on information in the asset records regarding the sequencing of maintenance and on the virtual model.

In yet another embodiment, at least one of the user devices comprises a geolocation unit for determining a location of the user device, and wherein information regarding status or completion of the building asset transmitted to the server further comprises the location of the user device.

In still yet another embodiment, the system further comprises one or more sensors for capturing data regarding the facility, each of the one or more sensors associated with one of the building assets, and each of the one or more sensors configured to transmit the data to the server for recordal in the asset record associated with the building asset associated with the sensor.

In a further embodiment, one or more of the asset records are generated, at least in part, by a building information model (BIM) system.

In still a further embodiment, the server is further configured to represent the virtual model as a three-dimensional representation of the facility, and wherein the three-dimensional representation is transmitted to one or more of the user devices and the administrator devices for viewing.

In still yet a further embodiment, the asset record comprises a historical record of information regarding status, completion, or activity regarding the building asset as transmitted by the user devices.

In still another embodiment, one or more of the asset tags comprise a transmitter and wherein each of the user devices are further configured to receive transmissions from the one or more asset tags.

In still yet another embodiment, each of the user devices are further configured to transmit to the server information regarding transmissions received from the one or more asset tags.

In yet another embodiment, the server is further configured to generate a digital map, based at least in part on the virtual model and on the information regarding transmissions received from the one or more asset tags, the digital map depicting, at least in part, relative locations of the one or more asset tags within the facility.

In still another embodiment, the relative locations of the one or more asset tags within the facility are determined, at least in part, using received signal strength indicator (RSSI) measurements.

In another embodiment, a method for managing construction of a facility with a plurality of building assets comprises (a) attaching one or more assets tag to the building assets, wherein each of the asset tags is associated with one of the building assets; (b) storing in a database one or more asset records, each of the one or more asset records associated with one of the building assets and comprising information regarding the building assets associated therewith; (c) generating by the server of a virtual model representing a current state of the facility based, at least in part, on the asset records; (d) providing one or more user devices; (e) interacting by one of the user devices with one of the asset tags to identify the building asset associated therewith; (f) transmitting by the user device to a server information regarding status or completion of the building asset; (g) recording by the server the information regarding status or completion of the building asset in an asset record associated therewith; (h) updating by the server of the virtual model; (i) providing one or more administrator devices; (j) transmitting by the administrator device to the server a request for information regarding one or more of the building assets; (k) accessing by server the asset records associated with the one or more of the building assets; (l) transmitting by the server to the administrator device information from the asset records; and (m) displaying by the administrator device the information from the asset records.

In a further embodiment, a method for managing maintenance of a facility with a plurality of building assets comprises (a) attaching one or more assets tag to the building assets, wherein each of the asset tags is associated with one of the building assets; (b) storing in a database one or more asset records, each of the one or more asset records associated with one of the building assets and comprising information regarding the building assets associated therewith; (c) generating by the server of a virtual model representing a current state of the facility based, at least in part, on the asset records; (d) providing one or more user devices; (e) interacting by one of the user devices with one of the asset tags to identify the building asset associated therewith; (f) transmitting by the user device to a server information regarding maintenance or testing of the building asset; (g) recording by the server the information regarding maintenance or testing of the building asset in an asset record associated therewith; (h) updating by the server of the virtual model; (i) providing one or more administrator devices; (j) transmitting by the administrator device to the server a request for information regarding one or more of the building assets; (k) accessing by server the asset records associated with the one or more of the building assets; (l) transmitting by the server to the administrator device information from the asset records; and (m) displaying by the administrator device the information from the asset records.

The foregoing was intended as a summary only and a description of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The invention will be described by reference to the detailed description of the embodiments and to the drawings thereof in which:

FIG. 1 depicts the system in accordance with one embodiment of the invention;

FIG. 2 depicts a facility that is managed by the system in accordance with one embodiment of the invention;

FIG. 3 depicts a process flow for the system in accordance with one embodiment of the invention;

FIG. 4 depicts another embodiment of the invention; and

FIG. 5 depicts yet another embodiment of the invention.

### DETAILED DESCRIPTION OF THE INVENTION

The embodiments described below set out the information necessary to enable a person skilled in the art to practice the embodiments and illustrate the best mode of practicing the embodiments. A person skilled in the art will understand the concepts of the detailed description and will recognize applications of these concepts that are not specifically addressed herein.

These concepts and applications fall within the scope of the detailed description and the accompanying embodiments.

The purpose of the terminology used in the detailed description is only for describing embodiments and is not intended to limit the scope of the disclosure. Words using the singular or plural form may also include the plural or singular form, respectively, where the context permits. When used in reference to a list of multiple items, the word or is intended to cover all of the following interpretations: any of the items in the list, all of the items in the list, and any combination of items in the list.

As used in the detailed description, unless specifically stated otherwise, the terms processing, calculating, determining, displaying, generating, or the like refer to the actions and processes of a computer or a similar electronic computing device that manipulates and transforms data represented as physical (electronic) quantities within the computer s memory or registers into other data similarly represented as physical quantities within the computer s memory, registers, or other such storage medium, transmission, or display devices.

As used in the detailed description, the terms connected, coupled, or the like may refer to any connection or coupling, either direct or indirect, between two or more elements. The coupling or connection between the elements may be physical, logical, or a combination of the two.

References to “an embodiment” or “one embodiment” mean that the particular feature, function, structure, or characteristic being described is included in at least one embodiment.

Occurrences of such phrases do not necessarily refer to the same embodiment, nor are they necessarily referring to alternative embodiments that are mutually exclusive of one another.

Unless otherwise noted, the words comprise and comprising are to be construed in an inclusive sense rather than an exclusive or exhaustive sense (i.e. in the sense of including but not limited to). The term based on is also to be construed in an inclusive sense rather than an exclusive or exhaustive sense. Unless otherwise noted, the term based on is intended to mean based at least in part on.

The term module refers broadly to software components, hardware components, and/or firmware components. Modules may be functional components that can generate useful data or other output(s) based on specified input(s). A module may be self-contained. A computer program may include one or more modules. Therefore, a computer program may include multiple modules responsible for completing different tasks or a single module responsible for completing multiple tasks.

The sequences of steps performed in any of the processes described in the detailed description are intended to be exemplary. Unless contrary to physical possibility, the steps may be performed in various sequences and combinations. For example, steps may be added to, or removed from, the processes described. Similarly, steps may be replaced or reordered. Therefore, the descriptions of any processes are intended to be open-ended.

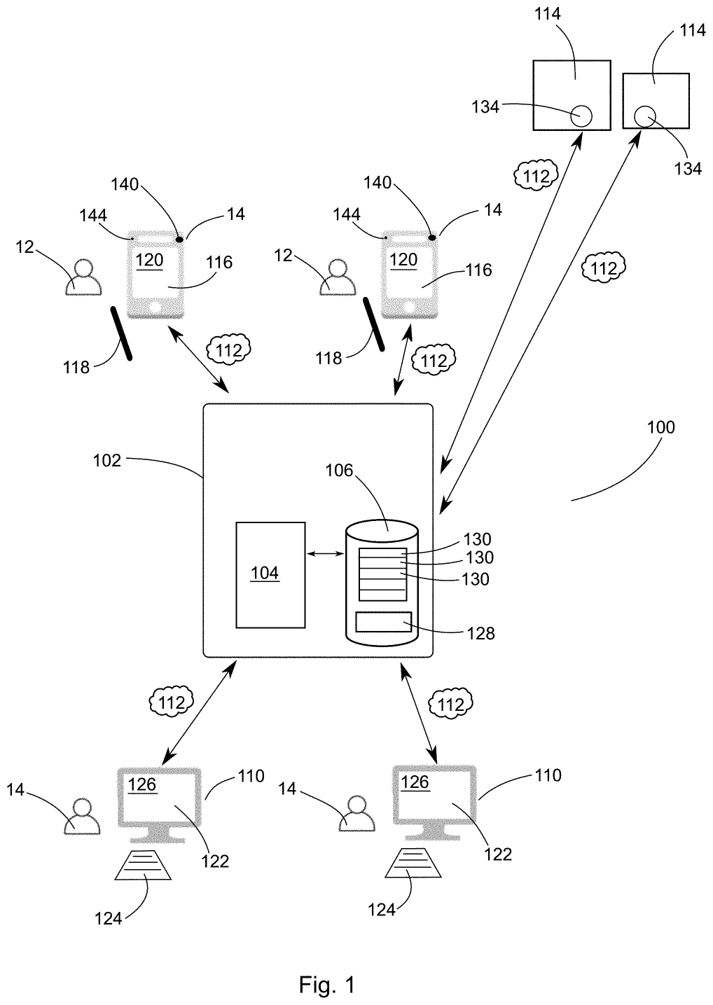

Referring to FIG. 1, according to one embodiment of the invention, a system 100 for managing construction and maintenance for one or more facilities 10 comprises a server 102 that is configured to host a software platform 104. The system 10 further comprises a database 106 configured to store information and data regarding the one or more facilities 10. The database 106 may be separate from, but accessible by, the server 102, or the database 106 may be within the server 102 itself.

The system 10 further comprises one or more user devices 108 and one or more administrator devices 110. The server 102, the one or more user devices 108, and the one or more administrator devices 110 are able to communicate with each other over a network 112. The network 112 may include one or more of local area networks (LANs), wide area networks (WANs), metropolitan area networks (MANs), and/or the Internet.

The user devices 108 are configured to allow for one or more first users 12 to update, preferably in real-time, a progress of completion of building assets 114 in facilities 10 that are under construction. The user devices 108 are also configured to allow for the one or more first users 12 to update, preferably in real-time, a progress of the testing, installation, and/or maintenance of the building assets 114 in facilities 10 that are already in operation.

As used herein, each of the building assets 114 may comprise a discrete component of the facilities 10 or a discrete segment of construction or installation of a fixture of the facilities 10. The building assets 114 may encompass discrete components of the facilities 10 or discrete segments of construction or installation of a fixture of the facilities 10 both when the facilities 10 are under construction and when the facilities 10 are completed and operational.

When used in the context of one of the facilities 10 under construction, the building assets 114 may include discrete components or discrete segments of construction or installation, which may need to be executed before a subsequent one of the building assets 114 can be scheduled or completed. By way of example only, the building assets 114 may include, but is not limited to, a concrete pour, a window, a door, a framing installation, and/or any modification to one of the building assets 114. The building assets 114 may also include diverse components of construction, including fire hydrants, manholes, or any other utility-type equipment that is connected to infrastructure. It may also include coatings, fixtures, surfaces, membranes, or built infrastructure (like sidewalks, streets, underground utilities, etc.).

When used in the context of one of the facilities 10 that is completed and operational, the building assets 114 may include discrete components or discrete segments of construction or installation that are anticipated to be periodically tested, adjusted, and/or maintained. In such a context, the building assets 114 may also include, but are not limited to, an electrical unit, pump, fan, boiler or HVAC unit, or the like, which may further be connected to an integrated system of pipes, wires, or ventilation as required to achieve the desired function. The building assets 114 may further include fire extinguishers, sensors or alarms, mechanical, electrical and plumbing assemblies, security and access control, and linear assets (e.g. underground utilities, electrical vaults, pipelines etc.).

It is understood that the same one of the building assets 114 may be used both for facilities 10 that are under construction and for facilities 10 that are completed and operational. For example, one of the building assets 114 present during construction of the facility 10 (e.g. a door) may later be one of the building assets 114 present after the facility 10 is completed and operational.

Each of the building assets 114 may be associated with an asset record 130. The asset record 130 is preferably stored in the database 106 and preferably includes information regarding the building asset 114. When the facility 10 is under construction, the asset record 130 may include information such as a bill of materials, instruction manuals, instructional videos, user warnings, specifications on the sequencing of the construction components, the identity of the person(s) who installed the building asset 114, photographs and images of the building asset 114, expected location of the building asset 114, and any testing or inspection that have been performed or permitted on the building asset 114. For example, the asset record 130 may include information on other ones of the building assets 114 that need to be completed prior to completion of the building asset associated with the asset record 130.

When the facility 10 is completed and operational, the asset record 130 may further include information such as photographs or images depicting the location or positioning of the building asset 114 once installed in the facility 10, the identities of the person(s) involved in the testing or maintenance of the building asset 114, and the dates and/or times of such testing or maintenance. The asset record 130 may comprise text information (e.g. expected location of the building asset 114) and may also comprise other types of data (e.g. image data, video data, etc.). The asset record 130 may be configured to store a historical record of all activities performed on the building asset 114 that have been recorded within the system 100.

The user devices 108 may be any computing device that is capable of displaying information to the first users 12, receiving inputs from the first users 12, and/or communicating over the network 112. Preferably, the user devices 108 are mobile computing devices that are carried or held by the first users 12. Examples of computing devices usable as the user devices 108 include mobile phones, tablets, laptop computers, or a wearable device (such as a smart watch).

The user devices 108 may be also configured to communicate over a direct peer-to-peer link, such as radio frequency communication, including, but not limited to, radio frequency identification (RFID), near-field communication (NFC), Bluetooth, Bluetooth Low Energy (BLE), Wi-Fi, or the like. Therefore, embodiments of the user devices 108 may include transceivers, chipsets, or other hardware enabling communications over a network and/or communications over one or more types of direct peer-to-peer channels.

Each of the user devices 108 preferably comprises a user display 116 configured to display an interactive user interface and a user input device 118 configured to receive inputs from the first user 12. The user display 116 may include a screen. The user input device 118 may include a keyboard, a mouse, a trackpad, a stylus, a camera, or the like. In some embodiments, the user display 116 may be the same component as the user input device 118, such as, for example, a touchscreen. Each of the user devices 108 includes one or more processors that execute a user application 120. The user application 120 generates the interactive user interface displayed to the first user 12 on the user display 116 and receives the inputs from the first user 12 via the user input device 118. The user application 120 is configured to communicate with the software platform 104 over the network 112.

The user devices 108 may, in some embodiments, also comprise a geolocation unit 144 that is configured to determine a location of the user device 108. One example of a geolocation unit 144 would be a Global Positioning System (GPS) receiver.

By interacting with the user application 120, each of the first users 12 is able to create a profile with the server 102 that is stored in the database 106. The profile may include information regarding the first user 12 and may also associate the first user 12 with one or more of the facilities 10. The profile may also include information to associate the first user 12 with one or more of the user devices 108.

The first user 12 is also able to interact with the user application 120 to enter information regarding completion and/or status of one or more of the building assets 114 in the facilities 10 under construction and associated with the first user 12, and to enter information regarding progress and/or status of the testing, installation, and/or maintenance of one or more of the building assets 114 in the facilities 10 that are already in operation and associated with the first user 12. This information may be entered into and included in the asset record 130 associated with the building asset 114 at issue. The first user 12 may enter or input the information using the user input device 118 on the user device 108, with the information being transmitted to the server 102 for updating of the database 106. Where the user device 108 comprises the geolocation unit 144, the user application 120 may also include location information of the user device 108 in the information transmitted to the server 102. In such cases, the asset record 130 may be updated to include the location information as well.

The first user 12 may further be able to retrieve certain information from the asset records 130 associated with some of the building assets 114. Depending on the permissions provided to the first user 12, the first user 12 may be able to retrieve information from the asset records 130, including bill of materials, instruction manuals, instructional videos, user warnings relating to the associated ones of the building assets 114.

Alternatively, instead of the user application 120, the software platform 104 may host a web application with which the first user 12 is able to interact using a browser on the user device 108.

The administrator devices 110 are configured to allow for one or more second users 14 to retrieve and view information about the building assets 114. For example, the second users 14 may be able to retrieve and view information from the asset records 130 associated with the building assets 114. The information may be at differing levels of detail, depending on the requirements of the second users 14 and the level of access provided to each of the second users 14. For example, depending on the level of access provided to a particular one of the second users 14, the particular one of the second users 14 may be allowed to only retrieve and view information regarding particular ones of the building assets 114. The information may be used by the second users 14 for various purposes, including, but not limited to, improving planning and scheduling of the completion of the building assets 114 (during construction) and/or the testing, installation, and maintenance of the building assets 114 (after construction).

The administrator devices 110 may be any computing device that is capable of displaying information to the second users 14, receiving inputs from the second users 14, and/or communicating over the network 112. Examples of computing devices usable as the administrator devices 110 include mobile phones, tablets, laptop computers, or desktop computers.

Each of the administrator devices 110 comprises an administrator display 122 configured to display an interactive user interface and an administrator input device 124 configured to receive inputs from the second user 14. The administrator display 122 may include a screen. The administrator input device 124 may include a keyboard, a mouse, a trackpad, or the like. In some embodiments, the administrator display 122 may be the same component as the administrator input device 124, such as, for example, a touchscreen. Each of the administrator devices 110 includes one or more processors that execute an administrator application 126. The administrator application 126 generates the interactive user interface displayed to the second user 14 on the administrator display 122 and receives the inputs from the second user 14 via the administrator input device 124. The administrator application 126 is configured to communicate with the software platform 104 over the network 112.

By interacting with the administrator application 126, each of the second users 14 is able to create a profile with the server 102 that is stored in the database 106. The profile may include information regarding the second user 14 and may also associate the second user 14 with one or more of the facilities 10. The profile may also include information to associate the second user 14 with one or more of the administrator devices 110.

The second user 114 is able to interact with the administrator application 126 to retrieve and view information regarding one or more of the building assets 114 in the facilities 10 associated with the second user 14. This information may be included in the asset record 130 associated with the building asset 114 at issue and may be viewed by the second user 14 using the administrator display 122 on the administrator device 110. For example, the server 102 may be configured to, upon request by the administrator application 126, retrieve one or more of the asset records 130 requested by the second user 114 from the database 106 and transmit the information to the administrator device 110 for viewing by the second user 114.

The second user 14 is also able to interact with the administrator application 126 to enter information regarding completion of one or more of the building assets 114 in the facilities 10 under construction and associated with the second user 14, and to enter information regarding progress of the testing, installation, and/or maintenance of one or more of the building assets 114 in the facilities 10 that are already in operation and associated with the second user 14. This information may be entered into and included in the asset record 130 associated with the building asset 114 at issue. The second user 14 may enter the information using the administrator input device 124 on the administrator device 110, with the information being transmitted to the server 102 for updating of the database 106.

Alternatively, instead of the administrator application 126, the software platform 104 may host a web application with which the second user 14 is able to interact using a browser on the administrator device 110.

The system 100 may include any number of the user devices 108 and the administrator devices 110. In addition, although the user devices 108 and the administrator devices 110 are depicted in FIG. 1 as being different devices, some implementations of the user devices 108 are similar or identical to some implementations of the administrator devices 110. Furthermore, a device that functions as one of the user devices 108 at one particular time may be used as one of the administrator devices 110 at some other time, and a device that functions as one of the administrator devices 110 may be used alternatively as one of the user devices 108.

It is understood that there may be multiple ones of the first users 12 and multiple ones of the second users 14. Each of the first users 12 and the second users 14 may have different roles and responsibilities, with correspondingly different permission levels for accessing information contained in the database 106. For example, the first users 12 may be only allowed to enter information regarding the building assets 114 in the facilities 10 with which the first users 12 are associated. Similarly, the second users 14 may be only allowed to retrieve and view information regarding the building assets 114 in the facilities 10 with which the second users 14 are associated.

For each of the facilities 10, the server 102 is configured to receive information regarding the building assets 114 thereof. The server 102 then records the information into the asset records 130 associated with the building assets 114. The server 102 may receive at least some of the information from the first users 12, who may enter the information using the user devices 108. The information regarding the building assets 114 may include the identity of the supplier, the identity of the installer, the time and date of installation, the materials used during installation, the identity of the maintenance provider, the time and date of maintenance, and the materials used during maintenance. Preferably, the information regarding the building assets 114 is received by the server 102 at the same time, or shortly after, an event relating to the building asset 114 occurs (e.g. installation, maintenance, etc.). The server 102 may record the information in the database 106 in the asset records 130 associated with the building assets 114.

For example, when the facility 10 is under construction, the server 102 is configured to, based on the information received by the server 102 regarding the completion of the building assets 114 and the timing thereof, generate a schedule for future construction activities. The schedule may be generated based on, at least in part, the completion of prerequisite activities and the sequencing of the construction components. This information regarding the completion of prerequisite activities and the sequencing of the construction components may be stored as part of the asset records 130 of the building assets 114. The server 102 is also configured to generate a record for reviewing past activities involving the building assets 114 for risk management and liability issues. The record may also be generated based on, at least in part, the information stored as part of the asset records 130 of the building assets 114.

When the facility 10 is already in operation, the server 102 is configured to, based on the information received by the server 102 regarding the maintenance of the building assets 114 and the timing thereof, generate a record of maintenance and service reports during a life of the facility 10. The record be also generated based on, at least in part, the information stored as part of the asset records 130 of the building assets 114. The record may be viewed by the first and second users 12, 14 using the user and administrator devices 108, 110, respectively. The server 102 may also be configured to generate a schedule for future maintenance and service activities, again based on, at least in part, the information stored as part of the asset records 130 of the building assets 114.

The server 102 may also be configured to provide differing levels of access (e.g. roles and permissions) to different ones of the first and second users 12, 14, depending on their profiles stored in the database 106. For example, where there are multiple companies or organizations involved in the construction or maintenance of the facility 10, different levels of access may be provided to different ones of the first and second users 12, 14 in the different companies or organizations. This may allow for more effective collaboration around a single set of data in the database 106 for the facility 10 and provides for a level of security to the information in the database 106.

The information received by the server 102 regarding the building assets 114 for the facilities 10 is stored in the database 106 as part of the asset records 130 associated with the building assets 114. The information from the asset records 130 for a particular one of the facilities 10 may be used to generate by the server 102 a virtual representation for the facility 10, which may be referred to as a virtual model 128. The virtual model 128 may be stored in the database 106 and comprises a collection of information regarding the building assets 114 (as stored as part of the associated ones of the asset records 130) of the facility 10. In one embodiment, the virtual model 128 may represent a current state of the facility 10.

In one embodiment, the first users 12 may be one or more of construction workers or service technicians who are responsible at the facility 10 (or at an associated site) for completing tasks related to the building assets 114 associated with the facility 10. For example, the task may involve the performance of a work order (e.g. installation) for one of the building assets 114 (when the facility 10 is under construction) or the testing or maintenance of one or the building assets 114 (after the facility 10 is operational). The first users 12 may be required to periodically update a completion status of the tasks relating to the building asset 114, or the commissioning and/or verification of such work. The first users 12 are able to do so by interacting with the user application 120 to enter information regarding the completion status of the tasks, with the information being transmitted to the server 102 for updating of the asset record 130 in the database 106 associated with the building asset 114.

The first users 12 are able to use the user devices 108 to transmit a data input to the server 102 reporting the completion status of one or more of the building assets 114. Based on the input received by the server 102 from the first users 12, the server 102 is configured to update the asset records 130 associated with the building assets 114. The server 102 is further configured to update the virtual model 128.

The second users 14 may be persons with a scope of responsibility in relation to the facility 10 (either under construction or in use and operational), who are able to use the administrator devices 110 to access the server 102 regarding information about the facility 10. In one embodiment, the server 102 is configured to generate the virtual model 128 for the facility 10 based, at least in part, on the asset records 130 stored in the database 106 regarding the building assets 114. The server 102 may also be configured to render the virtual model 128 as a three-dimensional representation of the facility 10, which may be viewed and manipulated by the first and second users 12, 14 using the user and administrator devices 108, 110, respectively.

The virtual model 128 may be considered as a composition of the building assets 114. As the asset records 130 for the building assets 114 are updated or inputted by the first users 12 using the user devices 108 and transmitted to the server 102, the server 102 is configured to store the information in the database 106 (in the associated ones of the asset records 130) and to update the virtual model 128.

The second users 14 are able to use the administrator devices 110 to access the server 102 to observe the progress and status regarding one or more of the building assets 114 in real time and to coordinate the planning, execution, installation, testing, and/or maintenance of one or more of the building assets 114. This may be done by requesting the server 102 to retrieve the asset records 130 associated with the one or more building assets 114. The status of a particular one of the building asset 114 may mean one or more of the following: a progress report, a completion report, a commissioning status, a verification status, a testing status, an installation status, or a maintenance status of the building asset 114.

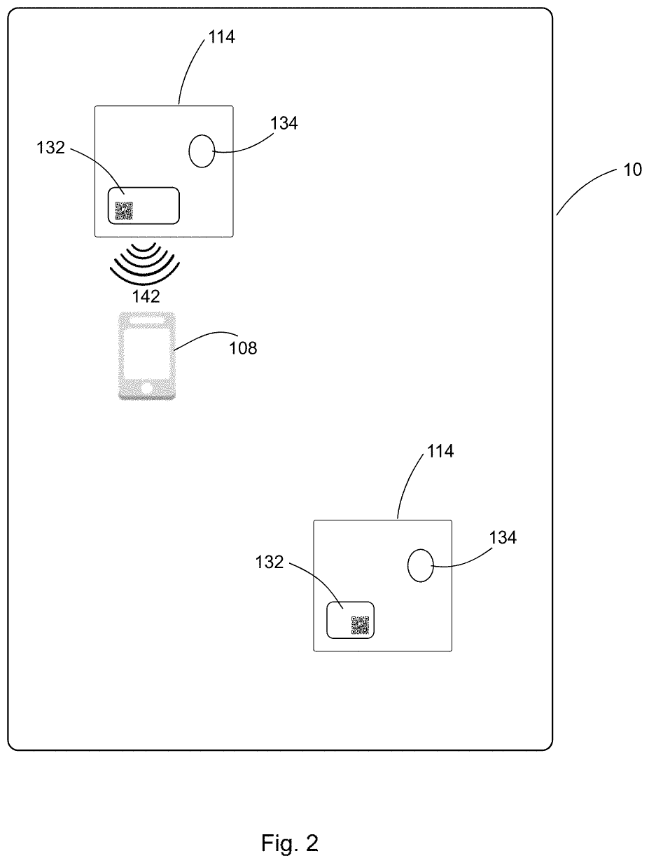

Referring to FIG. 2, in order to facilitate the recording and entry of the status of the building assets 114 by the first users 12, one or more of the building assets 114 may comprise an asset tag 132. The asset tag 132 may be a physical tag that is permanently or removably affixed to the building asset 114. The asset tag 132 may be used to identify the specific one of the building assets 114 for tracking by the server 102. Information about the building asset 114 associated with the asset tag 132 may comprise one or more of the following: the make, the brand, the type, the specifications, the date of manufacture, the date of delivery, the location at the facility 10, the location at any specific time point in the installation process, and/or any other pertinent detail regarding the building asset 114. In addition, the asset tag 132 may comprise a unique asset identifier 142 for the building asset 114. The information associated with the asset tag 132 may be stored on the asset tag 132 itself; alternatively, the asset tag 132 may comprise a link to another resource (e.g. a website, a database, etc.) that contains the information. The asset record 130 for the building asset 114 may also include information to associate the building asset 114 with the asset tag 132.

The asset tag 132 may be applied to the building asset 114 offsite (i.e. away from the facility 10) where the building asset 114 is first assembled or tested to allow for detailed tracking of the history of the location and testing for the building asset 114. Alternatively, the asset tag 132 may be applied to the building asset 114 on the site (i.e. at the facility 10). The asset tag 132 may comprise a QR code, a bar code, a NFC tag, a RFID tag, a BLE tag (or beacon), or the like. In addition, the asset tag 132 may be a virtual tag. At or around the time that the asset tag 132 is applied to the building asset 114, the asset record 130 for the building asset 114 preferably is updated to include information regarding the asset tag 132 associated with the building asset 114.

The asset tag 132 is preferably configured to interact with one of the user devices 108. For example, the user device 108 may comprise a camera 140 that is configured to scan a QR code or a bar code located on the asset tag 132. Alternatively, where the asset tag 132 comprises a NFC tag, a RFID tag, or a BLE tag (or beacon), the user device 108 may comprise an appropriate NFC reader, RFID reader, or BLE receiver, respectively, to interact with the asset tag 132. When the user device 108 interacts with the asset tag 132, the user device is able to determine the asset identifier 142 from the asset tag 132. This information may be transmitted to the server 102, which can then identify the building asset 114 associated with the asset tag 132.

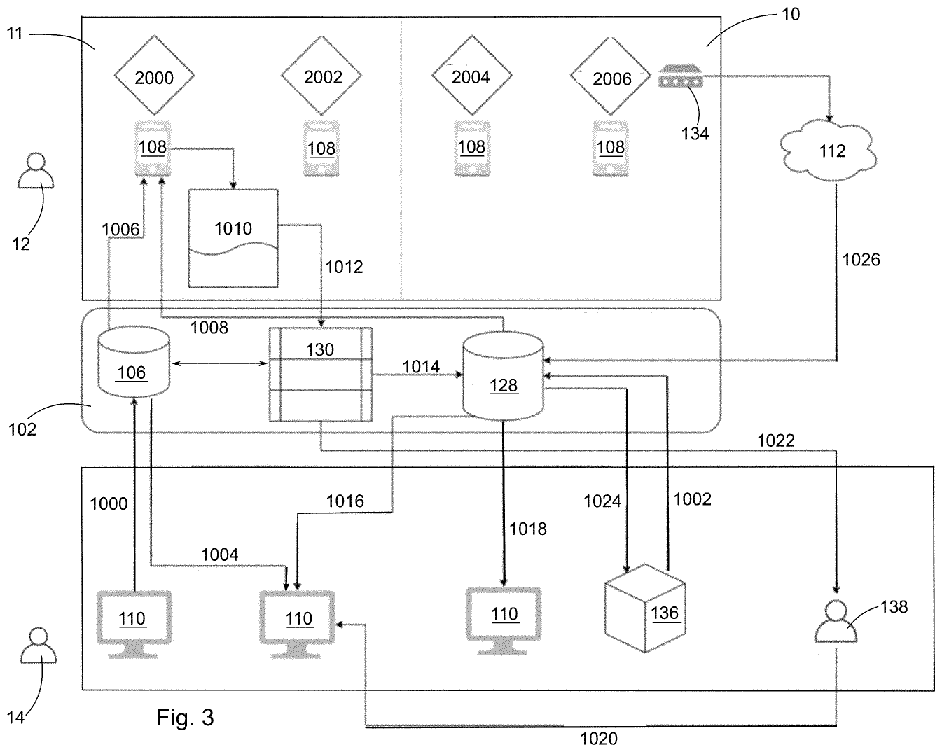

Referring to FIG. 3, a typical process flow for the system 10 will now be described.

In an initial setup phase, information regarding one of the facilities 10 may be inputted to the server 102, where it is stored in the database 106 (step 1000). This may be done, for example, by one or more of the second users 14, using the administrator devices 110. In one embodiment, different ones of the second users 14 may be assigned different levels of access or permissions. Accordingly, one or more of the second users 14 may be assigned with different permissions regarding which information they are allowed to enter regarding the facility 10. This information may include asset records 130 for the building assets 114 that are anticipated to be used in the construction of the facility 10 and procedures that others (including the first users 12) will use to complete their work, starting from written documentation, manufacturers recommendations, their own expertise, or instructions received from project stakeholders.

Furthermore, in some instances, a building information modelling (BIM) system 136 may initially be used in designing or planning the facility 10. In one embodiment, information from the BIM system 136 may also be transmitted to the server 102, which in turn may store the information in the database 106 (step 1002). The information from the BIM system 136 may also include asset records 130 for the building assets 114 that are anticipated to be used in the construction of the facility 10. The server 102 is configured to generate the virtual model 128 based, at least in part, on the information from the BIM system 136 along with any other data from the asset records 130 for the building assets 114. Furthermore, the information from the BIM system 136 may also be inputted to the server 102 by one or more of the second users 14 using the administrator devices 110. The BIM system 136 may be separate from the system 100 or may be part of the system 100.

After the initial setup phase has been completed, the server 102 has preferably generated the virtual model 128 for the facility 10, and the virtual model 128 is stored in the database 106. The server 102 is configured to generate a schedule for work visits. The work visits may be for installation of one or more of the building assets 114 or for the maintenance or testing of one or more of the building assets 114.

In the context of the facility 10 under construction, the schedule for work visits may be generated by the server 102 based on, at least in part, the information in the asset records 130 relating to the sequencing of the construction or installation of the building assets 114. In the context of the facility 10 already operational, the schedule for work visits may be generated by the server 102 based on, at least in part, the information in the asset records 130 relating to the dates and/or times of testing or maintenance of the building assets 114.

The schedule for the work visits may be communicated by the server 102 to one or more of the administrator devices 110 for viewing by one or more of the second users 14 (step 1004). In addition, one or more of the first users 12 may access the server 102 using the user devices 108 and download from the server 102 the schedule for work visits relating to the one or more first users 12 (shown as step 1006). The server 102 may be configured to only provide to the first users 12 a portion of the schedule for work visits, with the portion provided relating only to the particular ones of the first users 12. For example, the first users 12 that are involved in plumbing work would only be provided with the portion of the schedule for work visits relating to plumbing work assigned to those of the first users 12. The server 102 may be able to determine this based, at least in part, on the profiles for the first users 12.

Alternatively, instead of the first users 12 accessing the server 102 using the user devices 108 to download the schedule for work visits, the server 102 may transmit the schedule for work visits to the appropriate ones of the user devices 108. Even for ones of the first users 12 that are scheduled on the same work visit, there may be variability in the schedules. For example, each of the first users 12 working on the same work visit may have a different list of tasks to complete, as synchronized as between them and the server 102.

The first users 12 may also, using the user devices 108, download from the server 102 data relating to the virtual model 128 (step 1008), subject to the permission levels afforded to the first users 12. The data may include information about the facility 10 and information from the asset records 130 for the building assets 114 that form the basis of the virtual model 128. The data may also include information about the rooms and/or spaces in the facility 10, the asset tags 132 associated with the building assets 114, documents and photos regarding the facility 10, the permissions and access requirements for the facility 10, historical service information, and information regarding the building assets 114 (e.g. instruction manuals, etc.).

When the first users 12 complete the planned work set out in the schedule for work visits, the first users 12 are able to indicate this through the user devices 108, including by recording the appropriate information regarding the building assets 114 worked upon during the work visit (step 1010). The first users 12 may also include additional information, including for example, details of the completed steps, the time spent, and the materials used. This information may be transmitted by the user devices 108 to the server 102 (step 1012).

The server 102 is configured to process the information received from the user devices 108 regarding the completed work. Based on this information, the server 102 is further configured to update the information in the asset records 130 associated with the building assets 114 worked upon and to update the virtual model 128 (step 1014).

The server 102 is preferably configured to also identify any possible deficiencies in the work (e.g. if a specific task on one of the building assets 114 was not performed or not performed in the correct sequence). If the server 102 identifies a possible deficiency, the server 102 may generate a revised schedule for work visits to be transmitted to one or more of the user devices 108 and/or one or more of the administrator devices 110 (step 1016).

At the same time, the server 102 is also configured to generate one or more reports on the completed work and any deficiencies. The reports may be transmitted to one or more of the administrator devices 110 for viewing by one or more of the second users 14 (step 1018).

In another embodiment, the workflow can be initiated by a third-party requestor 138 (e.g. another company or organization). In this embodiment, the third-party requestor 138 may initiate a request that is transmitted to one or more of the administrator devices 110 for transmission to the server 102 (step 1020). The server 102 can then process the request and include the information in the request when generating the schedule for work visits.

In still another embodiment, the server 102 may be configured to generate an invoice or report to be transmitted to the third-party requestor 138, if appropriate (step 1022).

Throughout the construction process, the server 102 may communicate, from time to time, updates to the BIM system 136 for the facility 10 as work is completed on the building assets 114 (e.g. based on the status of the virtual model 128) (step 1024). When the project is finished, the BIM system 136 will be complete and will, as much as possible, accurately reflect the facility 10 as it was actually built.

In another embodiment, one or more of the building assets 114 may comprise a sensor 134 configured to capture particular data regarding the facility 10. There may be different types of the sensors 134 present, depending on the building asset 114 that the sensors 134 are associated with. The sensors 134 may capture information including environmental conditions (such as temperature, humidity, air quality, sound levels, etc.). The data captured by the sensor 134 may be transmitted to external Internet-of-things (IOT) systems or the like, which may in turn forward the relevant information to the server 102 for updating the asset records 130 associated with the building asset 114 and/or the virtual model 128 (step 1026). The data from the sensors 134 may be transmitted over the network 112. This information may also be included in the information that the first users 12 are able to retrieve to the user devices 108 from the server 102 (as part of step 1008). Preferably, the user devices 108 are able to receive the latest and most current data regarding the virtual model 128 shortly after data is updated.

The common industry use of the term work order typically implies a written document assigned for a task, but does not typically imply recording of details of activities done, or may only include a narrative of work performed and no machine-readable data about the work. When used herein, the term work order may also include a work assignment that tracks a potentially wide set of data including a bill of materials, the work being done, the work process visit, the individual pieces of equipment that are serviced, the standards employed, and such details as the time, location and name of the work team that performed the activity. As used herein, work order means that the work order project steps can be individually tracked with high granularity, and reported to and stored in the asset records 130 and the virtual model 128.

Such activities may also be referred to as a service plan, which is a list of the work to be done. This may involve more than one person in coordination. Within a work order, there may be multiple assets and multiple steps for servicing properly the task. The system 100 is able to capture each of the steps, with locations and persons responsible.

The use of the virtual model 128 may be distinguished from conventional building management software by the interaction of the first users 12, who are able to provide real-time inputs on the completion status of the building assets 114 as-built using the user devices 108, and the interaction of the second users 14, who are able to observe the completion status of one or more of the building assets 114. Furthermore, the server 102 is configured to generate schedules for further work packages based on pre-established dependencies (e.g. as stored in the asset records 130). Conventional building management software typically only creates a model of the assets, without consideration for how those assets physically change over time, whereas the system 100 is able to generate and update the virtual model 128 as required with reference to the asset records 130 (as they are updated) for the building assets 114.

The present invention provides a number of advantages for those involved in the construction and maintenance of facilities 10. In one example, the current industry standard around a poured concrete section provides a report of the activity being completed to the project manager s satisfaction. But this report typically loses many details as to the specific source of the concrete that was delivered, the duration of curing, the weather or temperature conditions at the time of the pour or set, the work crew that was responsible, and the record of sensor readings that may have been applied to track the curing. By contrast, the virtual model 128 is able to track and report all such information. The concrete source can be traced back from the supplier truck to the supplier source depending on how extensive tracking is implemented. The arrival of the concrete truck at the site, the delay before pumping and the duration of pumping can be fully recorded. This information may be stored in the asset records 130. The generation and the updating to the virtual model 128 also allows the second users 14 to undertake appropriate risk assessment and risk avoidance.

In another example, referring again to FIG. 3, one of the building assets 114 may be a unique architectural feature. The building asset 114 may be assembled offsite (e.g. at a location 11), with one of the asset tags 132 affixed to the building asset 114 and assigned a unique one of the asset identifiers 142. After the assembly of the building asset 114 offsite, one of the first users 12 may, using the user device 108, pair with, scan, or otherwise interact with the asset tag 132 (step 2000). Once the user device 108 has paired with or scanned the asset tag 132 to obtain the asset identifier 142, this may be sent to the server 102 in order to identify the building asset 114 associated with the asset tag 132. The corresponding one of the asset record 130 may then be retrieved from the database 106.

The first user 12 can then update the information in the asset record 130 (e.g. to indicate that the building asset 114 is ready for delivery) using the user device 108 (step 2002). The information may be transmitted to the server 102 and updated in the database 106. Based on this information, the virtual model 128 may be updated.

The second user 14 can identify (using the administrator device 110) via the virtual model 128 that the building asset 114 is ready for delivery. As the prerequisite assemblies are installed at the construction site, the server 102 may be configured to schedule delivery of the building asset 114. Alternatively, one of the second users 14 may manually schedule delivery of the building asset 114 through the administrator device 110.

Delivery to the facility 10 may also be recorded in the virtual model 128 by the server 102 after appropriate input by one of the first users 12 (through the user device 108). This may be done by one of the first users 12 pairing with or scanning the asset tag 132 of the building asset 114 after arrival at the facility 10 (step 2004). The first user 12 can then update the asset record 130 to indicate that the building asset 114 has been delivered.

The installation of the building asset 114 may be recorded by yet another one of the first users 12 using the user device 108 (step 2006). The verification and/or compliance testing of the installation can be recorded by still another one of the first users 12 using the user device 108. All along the chain, the server 102 may be configured to update the virtual model 128 each time that the asset record 130 for the building asset 114 was updated. In addition, all along the chain, one or more of the second users 14 can obtain granular information of the status of the construction for use in planning future steps.

In another example, one of the building assets 114 may comprise an electrical switch that is to be first tested offsite to ensure satisfactory performance. While offsite, one of the asset tags 132 may be affixed to the building asset 114. Upon completing satisfactory testing, the building asset 114 is approved for installation, and one of the first users 12 is able to pair with or scan the asset tag 132 with the user device 108 to identify the building asset 114. The first user 12 is then able to record, using the user device 108, information about the building asset 114 to the asset record 130 associated with the building asset 114. The information may include one or more of following: the approval, the make, the brand, the type, the specifications and/or any other pertinent detail. This information is transmitted to the server 102 for storage in the database 106 and for updating the virtual model 128.

The server 102 can then schedule the delivery of the building asset 114 to the facility 10 for installation. Alternatively, one of the second users 14 can manually schedule delivery of the building asset 114 through the administrator device 110.

Delivery of the building asset 114 at the facility 10 is recorded in the virtual model 128 by one of the first users 12 using the user device 108. Installation is recorded by another one of the first users 12 using the user device 108. In each case, details as to the time, the location, and the associated conditions of the installation may be included in the asset record 130 for the building asset 114, for use in updating the virtual model 128. In each case, the first users 12 may pair with, scan, or otherwise interact with the asset tag 132 in order to identify the building asset 114 and to allow for the server 102 to retrieve the appropriate one of the asset records 130. As installation is typically a multi-step process that may involve multiple trades across a variety of time periods, the progress of installation can be recorded by a plurality of the first users 12, each of whom records the completion of an aspect of the work using respective ones of the user devices 108. The second users 14 are able to observe the progress using the administrator devices 110 and schedule the next activities based on the progress observed.

The system 100 simplifies liability claims and insurance disputes often associated with building construction or maintenance to be settled on the basis of a fixed and permanent record of the building assets 114 (as recorded in the asset records 130). A vast range of details, including the time and date of the activities, the individuals involved, the location of the activity, and any aspect of the construction and maintenance process can be recorded in the virtual model 128 for future retrieval and use.

The system 100 allows for the visualization or reporting of the construction of the facility 10 in four dimensions (i.e. three dimensions plus time) in real-time, based on standardized inputs to the user devices 108.

The first or second user 12, 14 may be enabled to, via a viewer module, view and navigate the facility 10 via three-dimensional renderings displayed on the user and administrator devices 108, 110 respectively, which show both architectural features and the building assets 114.

Where the building assets 114 are connected assets (e.g. assets that are networked, for instance, via an IOT or BACnet arrangement), data and/or control functions for the building assets 114 may also be made available to the first and second users 12, 14 via the user and administrator devices 108, 110 respectively.

The use of the virtual model 128 is distinguished from conventional building management systems (BMS) in the sense that it provides a higher technology layer that allows users to access functionalities that optionally include conventional BMS data, but also data and information from a wider range of sources, such that further work packages can be scheduled, integrated and advanced more quickly. The system 100 allows for updating the virtual model 128 with as-built (i.e. make, model, serial, installation, specifications, including installation date, time, installers, materials used) data, time or material.

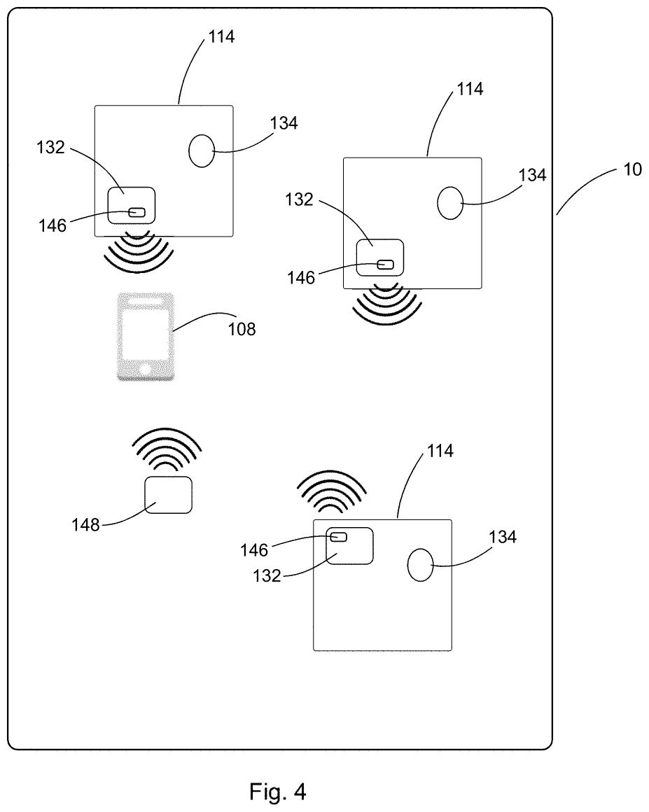

Referring to FIG. 4, due to the nature of the system 100, the system 100 may have other functionalities as well. For example, in one embodiment, the asset tags 132 on at least some of the building assets 114 have the ability to transmit data or signals. For example, the asset tags 132 may comprise a transmitter 146, which may include one or more of the following: a NFC tag, a RFID tag, a BLE tag (or beacon), or the like. The asset tags 132 may be configured to transmit data or signals, at least when one of the user devices 108 is within proximity. When one of the first users 12 is within the facility 10 and carrying one of the user devices 108, the user device 108 may be configured to continually interrogate any asset tags 132 that are nearby. If the user device 108 is able to identify and interrogate one of the asset tags 132, this information is transmitted to the server 102 for recordal in the asset records 130 associated with the building assets 114 for the asset tags 132. By collecting information from multiple ones of the user devices 108 interrogating multiple ones of the asset tags 132 from time to time, the server 102 is able to update the virtual model 128 to create a digital map of the facility 10, depicting, at least in part, the relative locations of the asset tags 132 within the facility 10. The user devices 108 may also use received signal strength indicator (RSSI) techniques on the signals received from the asset tags 132 to determine relative distances between the user devices 108 and the asset tags 132 during interrogation. This information may be used by the server 102 to further enhance the accuracy of the digital map.

The digital map of the facility 10 may change over time, as different ones of the building assets 114 are removed, replaced, or moved. These changes over time may be recorded in the asset records 130 in the database 106 and updated within the virtual model 128.

Subsequently, in one embodiment, if one of the user devices 108 detects a signal from an unidentified device 148 that is not recognized in the virtual model 128, this event may be marked by the server 102 and recorded in the database 106. The time of detection and the approximate location of the unidentified device 148 may also be recorded in the database 106. The server 102 may be configured to transmit a message to one of the second users 14 through the administrator devices 110 that further investigation of the unidentified device 148 may be required. The unidentified device 148 may be a malicious electronic device that requires further review.

As the first users 12 move through the facility 10 using the user devices 108, information regarding the asset tags 132 that are detected may be continually recorded and updated in the database 106 by the server 102. The server 102 may be configured to monitor the changes over time and to recognize unusual changes or activities that could be indicative of a cybersecurity risk.

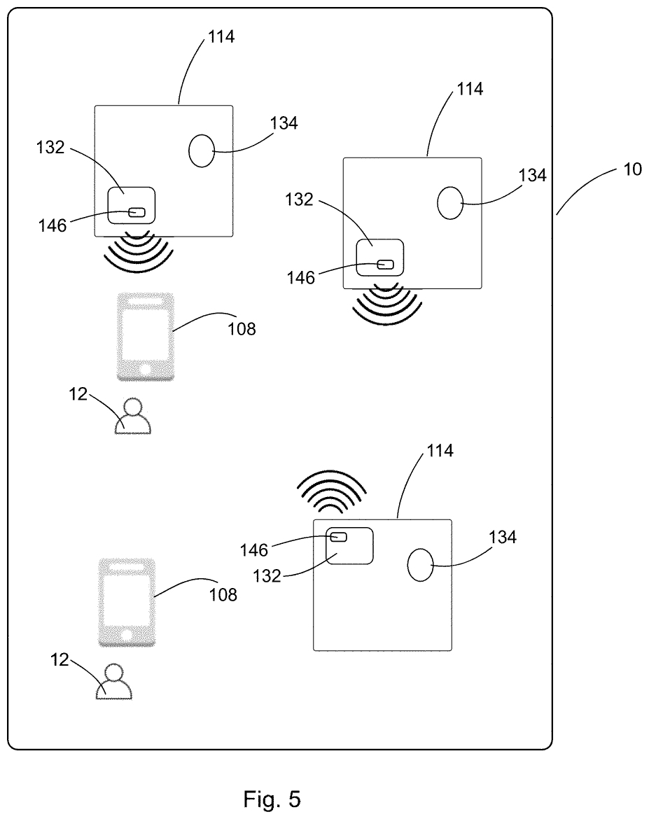

Referring to FIG. 5, in another embodiment, because the virtual model 128 includes information regarding the relative locations of one or more of the asset tags 132, this information may be used to locate one or more of the first users 12 within the facility 10. For example, the first users 12 will be carrying the user devices 108 as they move within the facility 10. As the first users 12 are moving within the facility 10, the user devices 108 may be (either continuously or from time-to-time) interrogating nearby ones of the asset tags 132. By identifying the asset tags 132 and retrieving their relative locations using the virtual model 128, the user device 108 may be able to determine a relative location of the user device 108 within the digital map of the facility 10. The user device 108 may further use RSSI techniques to further improve the accuracy of the location of the user device 108.

By determining the locations of the user device 108, the server 102 is able to identify which one of the first users 12 are located within the facility 10 and the approximate locations thereof. This information may be stored in the database 106 for retrieval and monitoring by one of the second users 14 using the administrator devices 110.

In one example, certain construction or maintenance activities may require a certain number of the first users 12 to be present. At or around the time that the construction or maintenance activity is carried out (as determined by the transmission of data from one of the user devices 108 to the server 102), the server 102 is able to determine whether the required number of the first users 12 is present.

In yet another embodiment, the system 100 is able to track and monitor data from across a number of the facilities 10. By tracking and monitoring data from a number of the facilities 10 regarding various ones of the building assets 114, improvements and changes to the installation, construction, or maintenance of the building assets 114 may be carried out. This data may come from the sensors 134 that detect various environmental measurements. By way of example only, certain requirements and procedures may be provided for a concrete pour associated with a particular structure (or building asset 114). For example, the concrete pour for the building asset 114 may require a prescribed minimum of seven days for the concrete to dry. One or more of the sensors 134 that are a part of, and associated with, the building asset 114 may be configured to measure the temperature of the concrete at various times. By aggregating the data from the sensors 134 with other ones of the sensors 134 in building assets 114 in different ones of the facilities 10, it may be possible to determine whether a shorter period of time may be sufficient to allow for the concrete to dry properly. This is possible because of the aggregation of the data from multiple ones of the facilities 10 provided by the system 100.

It will be appreciated by those skilled in the art that the preferred embodiments have been described in some detail but that certain modifications may be practiced without departing from the principles of the invention.

1. A system for management of construction and maintenance of a facility comprising a plurality of building assets, the system comprising:
a server;
a database in communications with the server, the database configured to store one or more asset records, each of the one or more asset records associated with one of the building assets and comprising information regarding the building assets associated therewith;
one or more asset tags, each of the one more asset tags attached to and associated with one of the building assets;
one or more user devices, each of the one or more user devices in communications with the server and configured to interact with one of the asset tags to identify the building asset associated therewith and to transmit to the server information regarding status, completion, or activity regarding the building asset for recordal in the asset record associated therewith; and
one or more administrator devices, each of the one or more administrator devices in communications with the server and configured to retrieve from the server information regarding one or more of the building assets by accessing the asset records associated therewith and to display the information regarding one or more of the building assets on the administrator devices;
wherein the server is further configured to generate a virtual model representing a current state of the facility based, at least in part, on the asset records.

2. The system of claim 1, wherein the information regarding status or completion of the building asset comprises one or more of the following: photographs, time stamps, textual feedback, measurements, and specifications.

3. The system of claim 2, wherein the information regarding status, completion, or activity regarding the building asset is recorded in the asset record associated with the building asset.

4. The system of claim 1, wherein the asset record further comprises information regarding a sequencing of construction involving the building asset associated therewith.

5. The system of claim 4, wherein the information regarding the sequencing of construction comprises information on other ones of the building assets that need to be completed prior to completion of the building asset associated with the asset record.

6. The system of claim 5, wherein the server is further configured to generate a schedule based, at least in part, on information in the asset records regarding the sequencing of construction and on the virtual model.

7. The system of claim 1, wherein the asset record further comprises information regarding a sequencing of maintenance involving the building asset associated therewith.

8. The system of claim 7, wherein the information regarding the sequencing of maintenance comprises information on other ones of the building assets that need to be worked on prior to maintenance of the building asset associated with the asset record.

9. The system of claim 8, wherein the server is further configured to generate a schedule based, at least in part, on information in the asset records regarding the sequencing of maintenance and on the virtual model.

10. The system of claim 1, wherein at least one of the user devices comprises a geolocation unit for determining a location of the user device, and wherein information regarding status or completion of the building asset transmitted to the server further comprises the location of the user device.

11. The system of claim 1, further comprising one or more sensors for capturing data regarding the facility, each of the one or more sensors associated with one of the building assets, each of the one or more sensors configured to transmit the data to the server for recordal in the asset record associated with the building asset associated with the sensor.

12. The system of claim 1, wherein one or more of the asset records are generated, at least in part, by a building information model (BIM) system.

13. The system of claim 1, wherein the server is further configured to represent the virtual model as a three-dimensional representation of the facility, and wherein the three-dimensional representation is transmitted to one or more of the user devices and the administrator devices for viewing.

14. The system of claim 3, wherein the asset record comprises a historical record of information regarding status, completion, or activity regarding the building asset as transmitted by the user devices.

15. The system of claim 1, wherein one or more of the asset tags comprise a transmitter and wherein each of the user devices are further configured to receive transmissions from the one or more asset tags.

16. The system of claim 15, wherein each of the user devices are further configured to transmit to the server information regarding transmissions received from the one or more asset tags.

17. The system of claim 16, wherein the server is further configured to generate a digital map, based at least in part on the virtual model and on the information regarding transmissions received from the one or more asset tags, the digital map depicting, at least in part, relative locations of the one or more asset tags within the facility.

18. The system of claim 17, wherein the relative locations of the one or more asset tags within the facility are determined, at least in part, using received signal strength indicator (RSSI) measurements.

19. A method for managing construction of a facility comprising a plurality of building assets, the method comprising:
attaching one or more assets tag to the building assets, wherein each of the asset tags is associated with one of the building assets;
storing in a database one or more asset records, each of the one or more asset records associated with one of the building assets and comprising information regarding the building assets associated therewith;
generating by the server of a virtual model representing a current state of the facility based, at least in part, on the asset records;
providing one or more user devices;
interacting by one of the user devices with one of the asset tags to identify the building asset associated therewith;
transmitting by the user device to a server information regarding status or completion of the building asset;
recording by the server the information regarding status or completion of the building asset in an asset record associated therewith;
updating by the server of the virtual model;
providing one or more administrator devices;
transmitting by the administrator device to the server a request for information regarding one or more of the building assets;
accessing by server the asset records associated with the one or more of the building assets;
transmitting by the server to the administrator device information from the asset records; and
displaying by the administrator device the information from the asset records.

20. A method for managing maintenance of a facility comprising a plurality of building assets, the method comprising:
attaching one or more assets tag to the building assets, wherein each of the asset tags is associated with one of the building assets;
storing in a database one or more asset records, each of the one or more asset records associated with one of the building assets and comprising information regarding the building assets associated therewith;
generating by the server of a virtual model representing a current state of the facility based, at least in part, on the asset records;
providing one or more user devices;
interacting by one of the user devices with one of the asset tags to identify the building asset associated therewith;
transmitting by the user device to a server information regarding maintenance or testing of the building asset;
recording by the server the information regarding maintenance or testing of the building asset in an asset record associated therewith;
updating by the server of the virtual model;
providing one or more administrator devices;
transmitting by the administrator device to the server a request for information regarding one or more of the building assets;
accessing by server the asset records associated with the one or more of the building assets;
transmitting by the server to the administrator device information from the asset records; and
displaying by the administrator device the information from the asset records.
